(19) United States
(12) Patent Application Publication
(10) Pub. No.: US 2014/0283344 A1
(43) Pub. Date: Sep. 25, 2014

(54) CLIP-CLAMP DEVICE AND METHOD

(71) Applicant: ERNESTO A. AGUERO-HERNANDEZ, Mound, MN (US)

(72) Inventor: ERNESTO A. AGUERO-HERNANDEZ, Mound, MN (US)

(21) Appl. No.: 14/295,513

(22) Filed: Jun. 4, 2014

Related U.S. Application Data
(60) Provisional application No. 61/983,373, filed on Apr. 23, 2014.

(51) Int. Cl. B65D 33/16; F16B 2/10

(52) U.S. Cl. CPC B65D 33/1675; F16B 2/10
USPC 24/545

(57) ABSTRACT

A clip-clamp device for preferably closing and sealing bags and the like. The clip-clamp device includes a closure assembly including a pair of lever members spatially arranged and facing one another and also including an interconnector extending between the lever members, and further Including at least one biased member connected to the lever members for memory retentiveness and to bias the lever members about and seal an opening of a container such as a bag.

### CROSS-REFERENCE TO RELATED APPLICATIONS

The present application claims the benefit of the U.S. non-provisional application Appl. No. 61/983,373, filed on Apr. 23, 2014, the disclosure of which is expressly incorporated by reference herein in its entirety.

### BACKGROUND OF THE INVENTION

1. Field of the Invention

The present invention relates to fasteners and more particularly pertains to a new clip-clamp device and method for preferably closing and sealing hags and the like.

2. Description of the Prior Art

The use of fasteners is known in the prior art. More specifically. fasteners heretofore devised and utilized are known to consist basically of familiar, expected and obvious structural configurations, notwithstanding the myriad of designs encompassed by the crowded prior art which have been developed for the fulfillment of countless objectives and requirements.

The prior art includes a highly stable clothespin of the type having a pair of elongated clamping members and a helical metal spring interposed therebetween. Each of the pair of clamping members has a forward clamping jaw, a tail, and an intermediate portion. The hollow body of the helical spring serves as a fulcrum about which the intermediate portions of the elongated clamping members are pivoted for opening and closing the jaws with respect to one another for gripping articles inserted therebetween. Another prior art includes an adjustable hose clip provided for use with a pool cleaner debris bag. including a first member having a retaining arm and a second member having a retaining arm. The hose clip also includes means for connecting the hose clip to a pool cleaner debris bag and resilient means for resilient biasing the retaining arms towards each other such that at least a portion of a pool hose can be retained between, the retaining arms. While these devices fulfill their respective, particular objectives and requirements, the aforementioned patents do not disclose a new clip-clamp device and method.

### SUMMARY OF THE INVENTION

The general purpose of the present invention, which will be described subsequently in greater detail, is to provide a new clip-clamp device and method which has many of the advantages of the fasteners mentioned heretofore and many novel features that result in a new clip-clamp device and method which is not anticipated, rendered obvious, suggested, or even implied by any of the prior art fasteners, either alone or in any combination thereof. The present invention includes a closure assembly including a pair of lever members spatially arranged and facing one another and also including an interconnector extending between the lever members, and further including at least one biased member connected to the lever members for memory retentiveness and to bias the lever members about and seal an opening of a container such as a bag. None of the prior art includes the combination of the elements of the present invention.

There has thus been outlined, rather broadly, the more important features of the clip-clamp device and method, in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a new clip-clamp device and method which has many of the advantages of the fasteners mentioned heretofore and many novel features that result in a new clip-clamp device and method which is not anticipated, rendered obvious, suggested, or even implied by any of the prior art fasteners, either alone or in any combination thereof.

Still another object of the present invention is to provide a new clip-clamp device and method for preferably closing and sealing bags and the like.

Still yet another object of the present invention is to provide a new clip-clamp device and method that conveniently gathers and guides the open end of a bag and the like within the clip-clamp device and method.

Even still another object of the present invention is to provide a new clip-clamp device and method that effectively clips and clamp shut the opening in the hag.

These together with other objects of the invention, along with the various features of novelty which, characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front elevational view of a new clip-clamp device and method according to the present invention.

FIG. 2 is a top perspective view of the present invention.

FIG. 3 is a side edge elevational view of the present invention.

### DETAILED DESCRIPTION OF THE INVENTION

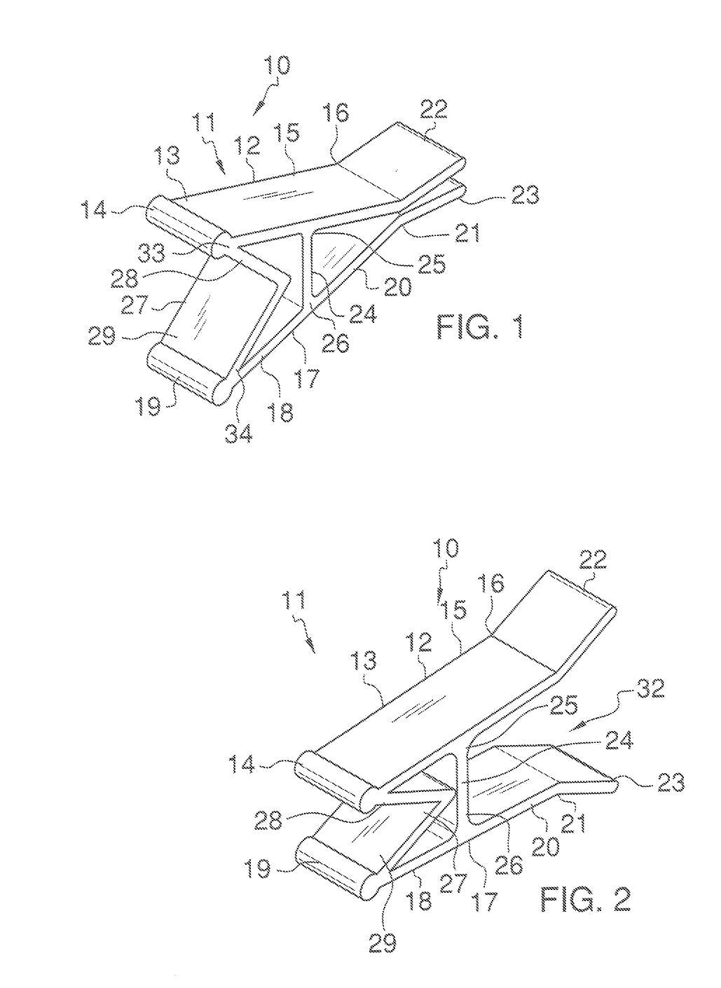

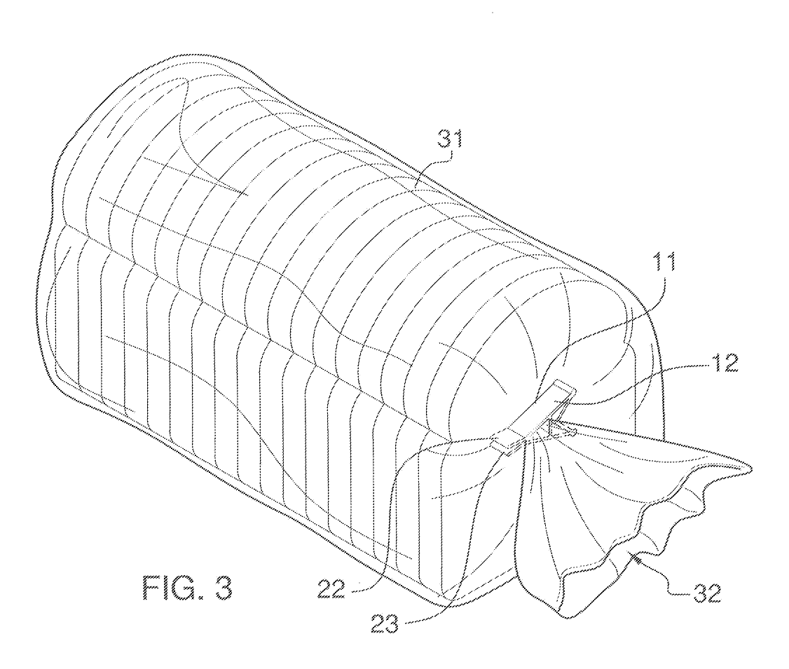

With reference now to the drawings, and in particular to FIGS. 1 through 3 thereof, a new clip-clamp device and method embodying the principles and concepts of the present invention and generally designated by the reference numeral 10 will be described.

As best illustrated in FIGS. 1 through 3, the clip-clamp device may generally comprise a closure assembly 11 including a pair of lever members 12, 17 made of any suitable material but preferably plastic and spatially arranged and facing one another and also including an interconnector 24 also made of any suitable material but preferably plastic and having enhanced memory retention as a result of the plastic and extending between the lever members 12, 17, and further including at least one biased member 27 made of any suitable material bat preferably plastic and having enhanced memory retention as a result of the plastic and integrally connected to the lever members 12, 17 to bias the lever members 12, 17 about and seal an opening 32 of a container 31 such as a bag containing bread and.

As shown in FIGS. 1 and 2, each of the lever members 12, 17 has a length and width and may include a handle portion 13, 18 having an enlarged cylindrical hack end 14, 19 to facilitate manipulating the handle portion 13, 18, and may also include a front portion 15, 20 integrally connected to and extending forward of the handle portion 13, 18 and having a front end 16, 21. The interconnector 24 may have ends 25, 26 each of which is integrally attached intermediate of a respective one of the lever members 12, 17 with the lever members 12, 17 capable of pivoting relative to the interconnector 24, the at least one biased

member 27 and to one another. The at least one biased member 27 may be integrally attached to the back ends 14, 19 of the handle portions 13, 18 and may extend therebetween to pivot the lever members 12, 17 and bias the front ends 16, 21 of the lever members 12, 17 substantially 25 together to enclose and seal about the opening 32 of the container 31. The at least one biased member 27 may include a pair of extended portions 28, 29 each having an end 33, 34 which is integrally and pivotally attached to a respective one of the back ends 14, 19 of the handle portions 13, 18 with the extended portions 28, 29 angled relative to one another and. having a length substantially less than that of the lever members 12, 17. The extended portions 28, 29 may extend inwardly of the closure assembly 11 and may extend from the back ends 14, 19 of the handle portions 13, 18 to a location proximate to the interconnector 24 where the extended portions 28, 29 integrally connect. The at least one biased member 27 may be a Y-shaped wedge to urge the handle portions 13, 18 away from one another and the front ends 16, 21 together for memory retention. As another embodiment, the at least one biased member 27 may be a semi-circular shaped wedge disposed between the handle portions 13, 18 of the lever members 12, 17.

As illustrated in FIGS. 1 and 2, the closure assembly 11 may also include guide members 22, 23 made of any suitable material but preferably plastic and integrally attached to and extending linearly and forwardly of the front ends 16, 21 of the lever members 12, 17 and may have lengths that are substantially less than that of the lever members 12, 17. The guide members 22, 23 may be angled away from one another when the front ends 16, 21 of the lever members 13, 18 are biased together and also when the front ends 16, 21 of the lever members 12, 17 are urged apart. Each of the guide members 22, 23 may be angled relative to the lever member 12, 17 to which the respective guide member 22, 23 is attached. The guide members 22, 23 may be angled approximately 90 degrees relative to one another when the front ends 16, 21 of the lever members 12, 17 are urged, apart to receive a portion of the container 31 therebetween.

In use, the front ends 16, 21 of the lever members 12, 17 may be urged apart to form an opening 30 therebetween. The user may grasp and squeeze the handle portions 13, 18 towards one another to urge the front ends 16, 21 of the lever members 12, 17 apart to form the opening 30 therebetween. At least a portion of a container 31 may be inserted between the lever members 12, 17 through the opening 30 between the front ends 16, 21. The portion of the container 31 proximate to the opening 32 is gathered between the guide members 22, 23. The portion of the container 31 proximate to the opening 32 in the container 31 may be inserted through the opening 30 between the lever members. The at 3 least one biased member 27 may urge the front ends 16, 21 of the lever members 12, 17 to close the opening 32 in the container 31. The user may release the handle portions 13, 18 whereupon the at least one biased member 27 urges the front ends 16, 21 of the lever members 12, 17 together to clip and clamp shut the opening 32 in the container 31.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent

relationships to those illustrated in the drawings and described in the specification are intended to be encompassed by the present invention.

Therefore, the foregoing is considered as illustrative only of the principles of the clip-clamp device. Further, since numerous

modifications and changes will readily occur to those skilled in the art, it is not desired to limit the invention to the exact construction and operation shown and described, and accordingly, all suitable modifications and equivalents may be resorted to, failing within the scope of the invention.

I claim:

1. A clip-clamp device comprising:
a closure assembly including a pair of lever members spatially arranged and facing one another and also including an interconnector extending between the lever members, and further including at least one biased member connected to the lever members to bias the lever members about and seal an opening of a container such as a bag as a result of memory retention.

2. The clip-clamp device as described in claim 1, wherein each of the lever members includes a handle portion having a back end, and also includes a front portion extending forward of the handle portion and having a front end.

3. The clip-clamp device as described in claim 2, wherein the interconnector has ends each of which is attached intermediate of a respective one of the lever members with the lever members capable of pivoting relative to the interconnector and to one another.

4. The clip-clamp device as described in claim 2. wherein the at least one biased member is attached to the back ends of the handle portions and extends therebetween to pivot the lever members and bias the front ends of the lever members together to enclose and seal about the container.

5. The clip-clamp device as described in claim 2, wherein the at least one biased member includes a pair of extended portions each having an end which is attached to a respective one of the back ends of the handle portions with the extended portions angled relative to one another.

6. The clip-clamp device as described in claim 2, wherein the extended portions extend inwardly of the closure assembly and extend from the back ends of the handle portions to a location proximate to the interconnector where the extended portions connect.

7. The clip-clamp device as described in claim 2, wherein the at least one biased member is a V-shaped wedge to urge the handle portions away from one another and the front ends together as a result of memory retention.

8. The clip-clamp device as described in claim 2, wherein the at least one biased member is a semi-circular shaped wedge disposed between the handle portions of the lever members to urge the handle portions away from one another and the front ends together as a result of memory retention.

9. The clip-clamp device as described in claim 2, wherein the closure assembly also includes guide members attached to and extending linearly and forwardly of the front ends of the lever members to gather and direct a portion of the container therebetween.

10. The clip-clamp device as described in claim 2, wherein the guide members are angled away from one another when the front ends of the lever members are biased together and also when the front ends of the lever members are urged apart.

11. The clip-clamp device as described in claim 2, wherein each of the guide members is angled relative to tire lever member to which the respective guide member is attached.

12. The clip-clamp device as described in claim 2, wherein the guide members are angled approximately 90 degrees relative to one another when the front ends of the lever members are urged apart to receive the portion of the container therebetween.

13. A method of using a clip-clamp device to close a container comprising the steps of:
providing a closure assembly including a pair of lever members having front ends and handle portions, an interconnector upon which the lever members are capable of pivoting, and at least one biased member biasing the front ends of the lever members together;
urging the front ends of the lever members apart to form an opening therebetween;
inserting at least a portion of a container between the lever members through the opening between the front ends; and
closing the front ends of the lever member to close an opening in the container.

14. The method, of using a clip-clamp device to close a container as described in claim 13, wherein the providing a closure assembly also includes providing guide members extending linearly from the front ends of the lever members.

15. The method of using a clip-clamp device to close a container as described in claim 14, wherein the urging the front ends include a user grasping and squeezing the handle portions towards one another to urge the lever members apart to form the opening therebetween.

16. The method of using a clip-clamp device to close a container as described in claim 15, wherein the inserting at least a portion includes gathering the portion of the container proximate to the opening between the guide members.

17. The method of using a clip-clamp device to close a container as described in claim 16, wherein the gathering the portion includes inserting the portion of the container proximate to the opening in the container through the opening between the front ends of the lever members.

18. The method of using a clip-clamp device to close a container as described in claim 17, wherein the closing the front ends includes releasing the handle portions whereupon the at least one biased member urges the front ends of the lever member together to clip and clamp shut the opening in the container.
